(19) United States
(12) Patent Application Publication
(10) Pub. No.: US 2023/0269200 A1
(43) Pub. Date: Aug. 24, 2023

(54) ON-CHIP NETWORK DESIGN METHOD FOR DISTRIBUTED PARALLEL OPERATION ALGORITHM

(71) Applicant: Yangtze Delta Reg Inst Huzhou Univ of Elect, Huzhou City (CN)

(72) Inventors: Letian HUANG, Huzhou City (CN); Ziyang DENG, Huzhou City (CN)

(21) Appl. No.: 18/068,710

(22) Filed: Dec. 20, 2022

(30) Foreign Application Priority Data
Feb. 24, 2022 (CN) 202210174904.0

(51) Int. Cl. H04L 49/109; H04L 49/00; H04L 49/201

(52) U.S. Cl. CPC H04L 49/109; H04L 49/201; H04L 49/3063; H04L 2012/5641

(57) ABSTRACT

The present disclosure relates to an on-chip network design method for a distributed parallel operation algorithm. According to a distributed parallel operation algorithm of an on-chip network, the on-chip network is divided into two layers, including a unicast network and a multicast network, where the unicast network is configured to implement point-to-point propagation between nodes and transmit independent operation data required by operation nodes to each operation node in a form of unicast; and the multicast network is a customized multicast network for the distributed parallel operation algorithm and configured to transmit common operation data to all the operation nodes, such that a data packet in the network is efficiently transmitted through a combination of the unicast network and the multicast network. By designing a multicast tree transmission architecture for the distributed parallel operation algorithm, a bidirectional replication node or a receiving node is disposed in each operation node.

### CROSS REFERENCE TO RELATED APPLICATION

This patent application claims priority to Chinese Patent Application No. 202210174904.0, filed with the China National Intellectual Property Administration on Feb. 24, 2022, the disclosure of which is incorporated by reference herein in its entirety as part of the present application.

### TECHNICAL FIELD

The present disclosure relates to the field of computer algorithm technologies, and in particular, to an on-chip network design method for a distributed parallel operation algorithm.

### BACKGROUND

Distributed parallel operation widely exists in various deep learning and target tracking algorithms. Distributed parallel computing may be defined as a series of algorithms that can be performed in parallel with same operation steps and without data dependency between different computing data during computation. Typical distributed operations include a distance operation between two coordinate vectors, various matrix multiplication, a convolution operation in a deep learning algorithm, and the like.

The distributed parallel operation is characterized by dense operation and decentralization and an independent operation between data. This type of operation involves a large amount of operations in current general purpose processors (CPUs) and general purpose graphics processors (GPGPUs), causing very low actual operation efficiency. Therefore, this patent designs an on-chip network architecture for this type of operation, which accelerates this type of algorithm in a form of customized hardware acceleration.

The most common method for designing a hardware accelerator for the distributed parallel operation is that a plurality of operation units are used, each unit is responsible for a part of the operation, all the units jointly perform the operation in parallel, and then final results are integrated. However, the biggest problem brought by this method is that when the computation results are integrated and stored into a storage unit, a relatively large quantity of operation units causes excessively large logic of decoding and selection combination of a control signal of the storage unit and poor timing during storage of the result. This affects a clock with the highest frequency, resulting in reduction of the overall performance.

To resolve the problem of excessively large logic delay of the parallel operation combination of the plurality of operation units, in the industry, the operation units are interconnected generally by using an on-chip network rather than a bus and a switching matrix. A networking communication structure has more advantages than the bus in an on-chip many-core system: the communication structure can support parallel data transmission, has a topology structure that is easier to expand, and has a wider communication bandwidth. The networking communication system further provides rich redundant resources, and has more choices in reliability design. An on-chip network is widely concerned and applied as a representative of the networking communication structure. FIG. 1 is a common 2D-Mesh structure of an on-chip network. The 2D-Mesh structure mainly includes a router, a link, and a network interface, where a processing unit may be formed by a memory interface, a general processor, a hardware acceleration unit, an I/O interface, and the like.

Transmission in the on-chip network is mainly in a form of receiving and sending of a packet. The router is a main component of the on-chip network and is mainly responsible for temporary storage and orientation of data packets, which may be understood as a transfer station for data transmission in the network. The link connects various components of the on-chip network into a connected network, and a packet is received and sent through a connection between an output register of the upstream router and an input buffer of the downstream router. The network interface is responsible for packing and sending data of the processing unit and unpacking and sending the packet sent from the router to the processing unit.

A data packet of the on-chip network may be sent by a source node to one or more destination nodes, which is referred to as unicast when there is only one destination node and is referred to as multicast when there are a plurality of destination nodes. The multicast packet needs to store locations of the plurality of destination nodes with a more complex data packet format than a unicast packet format. A current common multicast policy includes performing a multicast operation in a form of unicast, that is, sequentially sending the unicast packet to the plurality of destination nodes. This solution is simple to implement but greatly increases network traffic. Another manner is referred to as virtual circuit tree multicasting (VCTM), which adds a routing table to each routing table. Before each multicast starts, a configuration packet of the multicast is sent to a routing table of a corresponding node in the form of unicast. When the multicast packet is sent, a fork direction and whether the router forks are configured according to a corresponding same index ID of the routing table. The problem brought by this type of general multicast network is that a packet load in the network is increased, and the routing resource consumption of the on-chip network is greatly increased.

The current general purpose processors (CPU) and the general purpose graphics processors (GPGPU) are difficult to meet a real-time requirement of the distributed parallel operation algorithm. Therefore, customized hardware needs to be designed according to the features of the algorithm.

In this application, by designing a customized on-chip network for the algorithm, the problem of relatively low clock frequency caused by the excessively large delay of bus interconnection and combination logic of the conventional hardware accelerator including the plurality of operation units is resolved, and problems of low network communication efficiency and more hardware resources consumed by the network caused by sharing a network by unicast and multicast of the general on-chip network are also resolved.

Because the on-chip network is oriented to the distributed parallel operation algorithm, and this type of algorithm has a similar operation structure, this type of operation may be divided into a plurality of groups. For example, there are several typical algorithms in this type of algorithm: all distance operations between coordinates in two coordinate vectors, where operations between coordinates M and different coordinates N are sequentially performed; two matrix multiplication, where multiplication operations between a row P and different columns Q are performed; and a convolution operation, where convolution is performed between a same convolution kernel and different matrices. The feature of performing an operation by using same data of this type of operation corresponds to a multicast scenario of the on-chip network, that is, only the same operation data is sent from a data receiving node to each operation node. However, in the conventional multicast method, all nodes can send multicast packets, which occupy a large amount of on-chip resources during implementation, and also causes the redundancy of hardware resources.

In order to save the on-chip resources to the maximum extent while ensuring the multicast efficiency of the distributed parallel operation algorithm implemented on the on-chip network, this application provides a new network structure of a unicast network plus a directed multicast network, and a multicast network for a distributed parallel operation algorithm is designed based on a common mesh network. The multicast network is the directed multicast network, and a data input node, as a source, sends multicast data to each operation node. In this application, by designing a tree replication circuit unit for the multicast scene, the multicast data is transmitted quickly without consuming more on-chip resources, thereby effectively improving the overall network communication efficiency.

### SUMMARY

### (I) Technical Problems

To resolve the problem of relatively low clock frequency caused by the excessively large delay of bus interconnection and combination logic of the conventional hardware accelerator including the plurality of operation units, and problems of low network communication efficiency and more hardware resources consumed by the network caused by sharing a network by unicast and multicast of the general on-chip network, an on-chip network design method for a distributed parallel operation algorithm is provided.

### II. Technical Solutions

An on-chip network design method for a distributed parallel operation algorithm is provided, where the method includes: according to a distributed parallel operation algorithm of an on-chip network, dividing the on-chip network into two layers, including a unicast network and a multicast network, where the unicast network is configured to implement point-to-point propagation between nodes and transmit independent operation data required by operation nodes to each operation node in a form of unicast; and the multicast network is a customized multicast network for the distributed parallel operation algorithm and configured to transmit common operation data to all the operation nodes, such that a data packet in the network is efficiently transmitted through a combination of the unicast network and the multicast network.

As a preferred technical solution, the multicast network includes two types of nodes, namely, bidirectional replication nodes and receiving nodes, where a next level of each of the bidirectional replication nodes is connected to two bidirectional replication nodes or receiving nodes, all the nodes in the multicast network jointly form a tree node graph, each multicast operation is transmitted from a top node of the tree to all bottom nodes of the tree, and reasonable design of the bidirectional replication node and the receiving node ensures better performance when resource usage is relatively small.

As a preferred technical solution, the bidirectional replication node decodes and stores data in a multicast packet sent by a previous level and copies and transmits the data packet to two nodes at a next level, and a node at the last level is the receiving node that receives and decodes the multicast packet and stores the data.

As a preferred technical solution, a running process of the entire on-chip network is as follows:

s1: when an algorithm operation starts, a data input node receives multicast data and unicast data sent by a sensor, and then the node packs the multicast data and performs a multicast operation on the multicast data by using the multicast network, sends the multicast data to each operation node, and then sequentially packs and sends the unicast data to a corresponding operation node in the unicast network by using a unicast operation; and

s2: each operation node starts an operation after receiving the corresponding multicast data and the corresponding unicast data, and continuously packs and sends an operation result to a storage node during the operation until all distributed parallel operations are completed, and an RISC-V processor node accesses the stored data by using the unicast network.

### (III) Beneficial Effects

The present disclosure has the following beneficial effects:

1. The on-chip network is oriented to the distributed parallel operation algorithm, and provides a hardware acceleration solution for this type of algorithm.

2. The on-chip network separates multicast and unicast by designing an independent multicast network, which resolves problems of large traffic and easy network congestion in a single network.

3. By designing a multicast tree transmission architecture for the distributed parallel operation algorithm, only bidirectional replication nodes or receiving nodes are set in each operation node. Different from a case that each node in the conventional multicast on-chip network has multicast sending and receiving modules, this architecture minimizes the use of on-chip resources. The exponential growth of a quantity of nodes mounted at each level of the tree structure also effectively reduces a total delay of multicast packet transmission from the top to the bottom, and effectively improves the real-time performance of the operation algorithm of the on-chip network.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a typical structural diagram of a MESH on-chip network.

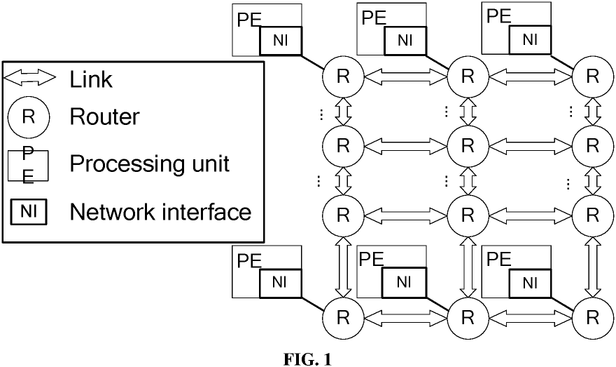

FIG. 2 is an architecture diagram of a dual-layer on-chip network.

FIG. 3 is a micro architecture of a bidirectional replication node.

### DETAILED DESCRIPTION OF THE EMBODIMENTS

A further description is made on the on-chip network design method for a distributed parallel operation algorithm in the present disclosure with reference to the accompanying drawings, and the following further describes the present disclosure in detail with reference to the embodiments.

An on-chip network design method for a distributed parallel operation algorithm is provided, where the method includes: according to a distributed parallel operation algorithm of an on-chip network, dividing the on-chip network into two layers, including a unicast network and a multicast network, where the unicast network is configured to implement point-to-point propagation between nodes and transmit independent operation data required by operation nodes to each operation node in a form of unicast; and the multicast network is a customized multicast network for the distributed parallel operation algorithm and configured to transmit common operation data to all the operation nodes, such that a data packet in the network is efficiently transmitted through a combination of the unicast network and the multicast network.

Further, the multicast network includes two types of nodes, namely, bidirectional replication nodes and receiving nodes, where a next level of each of the bidirectional replication nodes is connected to two bidirectional replication nodes or receiving nodes, all the nodes in the multicast network jointly form a tree node graph, each multicast operation is transmitted from a top node of the tree to all bottom nodes of the tree, and reasonable design of the bidirectional replication node and the receiving node ensures better performance when resource usage is relatively small.

Further, the bidirectional replication node decodes and stores data in a multicast packet sent by a previous level and copies and transmits the data packet to two nodes at a next level, and a node at the last level is the receiving node that receives and decodes the multicast packet and stores the data.

Further, a running process of the entire on-chip network is as follows:
s1: when an algorithm operation starts, a data input node receives multicast data and unicast data sent by a sensor, and then the node packs the multicast data and performs a multicast operation on the multicast data by using the multicast network, sends the multicast data to each operation node, and then sequentially packs and sends the unicast data to a corresponding operation node in the unicast network by using a unicast operation; and
s2: each operation node starts an operation after receiving the corresponding multicast data and the corresponding unicast data, and continuously packs and sends an operation result to a storage node during the operation until all distributed parallel operations are completed, and an RISC-V processor node accesses the stored data by using the unicast network.

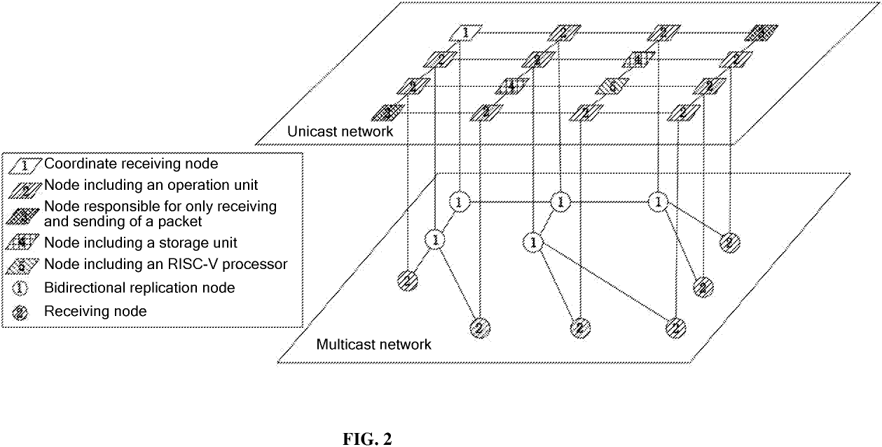

Working principle: As shown in FIG. 2, a unicast network adopts an on-chip network of an N*N Mesh network topology. There are the following nodes in the unicast network in the network: 1. Data input node, responsible for receiving newly sensed data transmitted by a sensor or an upper level of the network, correspondingly packing the data into a unicast packet and a multicast packet, and respectively sending the data packets to corresponding operation nodes through the unicast network and the multicast network. 2. Node including operation units, responsible for unpacking and storing the data packets after receiving the unicast packet and the multicast packet sent to the node. Then the operation node invokes data corresponding to the multicast packet and the unicast packet for operation and packs and sends a computation result to a corresponding storage unit. 3. Node only responsible for receiving and sending of a packet. This type of node is only responsible for propagating packets in the unicast network to destination nodes in an X direction or Y direction without unpacking and storing data into the storage unit. 4. Node including a storage unit. This type of node stores all valid results and supports another node in sending a request to the node. After receiving the request, the node returns a packet including requested data to the another node. 5. Node including an RISC-V processor. An RISC-V processor is mounted on the node and configured to complete algorithms other than the computation content of the computing unit of the on-chip network. For example, after the on-chip network completes a convolution operation in a deep learning algorithm, the RISC-V processor invokes data in a storage node to complete subsequent operations such as pooling and full connection.

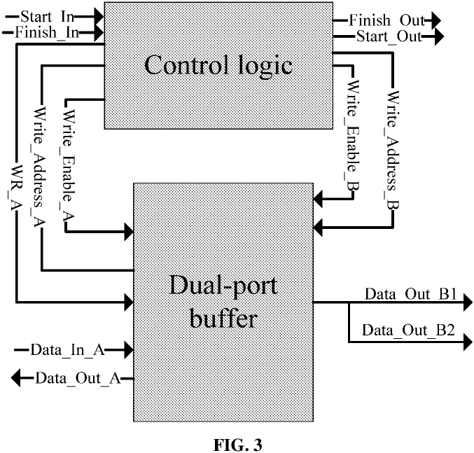

The multicast network includes bidirectional replication nodes and receiving nodes, where a next level of each of the bidirectional replication nodes is connected to two bidirectional replication nodes or receiving nodes, and all the nodes in the multicast network jointly form a tree node graph Each multicast operation is transmitted from a top node of the tree to all bottom nodes of the tree. A micro architecture of a bidirectional replication node is shown in FIG. 3 and includes two parts of control logic and a dual-port buffer. After the control logic receives a Start_In signal, it indicates that an end B of the dual-port buffer at a previous level starts transmitting data, then the control logic at this level sends a written address and an enabling signal to a port A of the dual-port buffer, and stores data sent by a previous level until the previous level sends a Finish_In signal, to complete storage of all data. Then, the control logic at this level sends a Start_Out signal and starts sending a read address and a read enabling signal to a port B of the dual-port buffer and sends a Finish-Out signal after all the data sent by the previous level is sent completely. After this level completes the multicast operation, the control logic invokes a read operation of the port A again, to read valid data in the multicast packet, and invokes the operation unit with reference to data in the unicast packet to complete the operation.

The foregoing embodiments are only intended to describe the preferred implementations of the present disclosure, rather than limiting the concept and scope of the present disclosure. Various modifications and improvements made on the technical solution of the present disclosure by those of ordinary skills in the art without departing from the design concept of the present disclosure shall fall within the claimed scope of the present disclosure. The technical content claimed by the present disclosure has been fully recorded in the claims.

What is claimed is:

1. An on-chip network design method for a distributed parallel operation algorithm, the method comprising:
according to a distributed parallel operation algorithm of an on-chip network, dividing the on-chip network into two layers, comprising a unicast network and a multicast network;
wherein the unicast network is configured to implement point-to-point propagation between nodes and transmit independent operation data required by operation nodes to each operation node in a form of unicast; and
wherein the multicast network is a customized multicast network for the distributed parallel operation algorithm and configured to transmit common operation data to all the operation nodes, such that a data packet in the network is efficiently transmitted through a combination of the unicast network and the multicast network.

2. The on-chip network design method according to claim 1, wherein the multicast network comprises two types of nodes, namely, bidirectional replication nodes and receiving nodes, wherein a next level of each of the bidirectional replication nodes is connected to two bidirectional replication nodes or receiving nodes, all the nodes in the multicast network jointly form a tree node graph, each multicast operation is transmitted from a top node of the tree to all bottom nodes of the tree, and reasonable design of the bidirectional replication node and the receiving node ensures better performance when resource usage is relatively small.

3. The on-chip network design method according to claim 2, wherein the bidirectional replication node decodes and stores data in a multicast packet sent by a previous level and copies and transmits the data packet to two nodes at a next level, and a node at the last level is the receiving node that receives and decodes the multicast packet and stores the data.

4. The on-chip network design method according to claim 1, wherein a running process of the entire on-chip network is as follows:
s1: when an algorithm operation starts, a data input node receives multicast data and unicast data sent by a sensor, and then the node packs the multicast data and performs a multicast operation on the multicast data by using the multicast network, sends the multicast data to each operation node, and then sequentially packs and sends the unicast data to a corresponding operation node in the unicast network by using a unicast operation; and
s2: each operation node starts an operation after receiving the corresponding multicast data and the corresponding unicast data, and continuously packs and sends an operation result to a storage node during the operation until all distributed parallel operations are completed, and an RISC-V processor node accesses the stored data by using the unicast network.

5. The on-chip network design method according to claim 2, wherein a running process of the entire on-chip network is as follows:
s1: when an algorithm operation starts, a data input node receives multicast data and unicast data sent by a sensor, and then the node packs the multicast data and performs a multicast operation on the multicast data by using the multicast network, sends the multicast data to each operation node, and then sequentially packs and sends the unicast data to a corresponding operation node in the unicast network by using a unicast operation; and
s2: each operation node starts an operation after receiving the corresponding multicast data and the corresponding unicast data, and continuously packs and sends an operation result to a storage node during the operation until all distributed parallel operations are completed, and an RISC-V processor node accesses the stored data by using the unicast network.

6. The on-chip network design method according to claim 3, wherein a running process of the entire on-chip network is as follows:
s1: when an algorithm operation starts, a data input node receives multicast data and unicast data sent by a sensor, and then the node packs the multicast data and performs a multicast operation on the multicast data by using the multicast network, sends the multicast data to each operation node, and then sequentially packs and sends the unicast data to a corresponding operation node in the unicast network by using a unicast operation; and
s2: each operation node starts an operation after receiving the corresponding multicast data and the corresponding unicast data, and continuously packs and sends an operation result to a storage node during the operation until all distributed parallel operations are completed, and an RISC-V processor node accesses the stored data by using the unicast network.
